(19) United States
(12) Patent Application Publication
(10) Pub. No.: US 2023/0272593 A1
(43) Pub. Date: Aug. 31, 2023

(54) AN ACCESS CONTROL SYSTEM FOR AN EXCAVATOR

(71) Applicant: HEXEX PTY LTD, Sydney, New South Wales (AU)

(72) Inventor: Duncan MILLER, Molendinar (AU)

(21) Appl. No.: 18/007,326

(22) PCT Filed: Jul. 23, 2021
(86) PCT No.: PCT/AU2021/050793

§ 371 Date: Jan. 30, 2023

(30) Foreign Application Priority Data
Aug. 5, 2020 (AU) 2020902738

(51) Int. Cl. E02F 9/08; E02F 9/20; B60R 3/02; B60Q 9/00; B60Q 5/00; B60R 25/00

(52) U.S. Cl. CPC E02F 9/0833; E02F 9/2004; B60R 3/02; B60Q 9/00; B60Q 5/005; B60R 25/00

(57) ABSTRACT

An access control system for an excavator access system has a ladder control lever connected to a hydraulic system of the access system. The lever has an up position which raises the ladder, a down position which lowers the ladder and a neutral position. The lever returns itself to the neutral position. The control system has a latching control circuit comprising a ladder valve contact switch operably coupled to the ladder control lever; a ladder position sensor which detects if the retractable ladder is in the raised position and a latching valve relay controlling a latching valve which controls the hydraulic cylinder. The control system controls the hydraulic cylinder to keep the retractable ladder in the raised position when the ladder valve contact switch indicates that the ladder control lever is in the neutral position and the ladder position sensor detects that the retractable ladder is in the raised position.

### FIELD OF THE INVENTION

This invention relates generally to an access control system for an excavator which improves safety.

### BACKGROUND OF THE INVENTION

Access control systems are used to gain access to large excavators, such as the Cat 6040™ hydraulic mining shovel. The access control system comprises a retractable ladder between a control cabin of the excavator and ground level.

A hydraulic system having at least one hydraulic cylinder is connected to the retractable ladder to raise and lower the retractable ladder between raised and lowered positions.

A manually operated access control lever controls the hydraulic cylinder. The control lever normally controls a bi-positionable detented valve which can be put in either an up position or a down position.

As such, to raise the retractable ladder, the lever is put in the up position which pressurises the hydraulic cylinder to raise the retractable ladder. During operation, the lever is left in the up position to keep the hydraulic cylinder pressurised to keep the retractable ladder raised.

To lower the retractable ladder, the lever is put in the down position which releases pressure of the hydraulic cylinder.

The lever is configured for “dead machine control” to release pressure of the hydraulic cylinder even if the excavator engine has stopped running resulting in a loss of hydraulic pressure. As such, the lever may be used to bring the retractable ladder to ground under gravity even if the engine has stopped.

A problem such access control systems however is that the access control system may be inadvertently activated and further that the ladder moves continuously depending on the lever position. As such, the ladder may move with an operator thereon or standing nearby and, in some cases, operators have been killed by moving retractable ladders.

The present invention seeks to provide an improved access control system, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

An access control system comprises a ladder control lever connected to a hydraulic system controlling a hydraulic cylinder to raise or lower a retractable ladder between raised and lowered positions.

The lever has an up position which raises the ladder and a down position which lowers the ladder. The lever may pressurise the hydraulic cylinder in the up position and may release pressure from the hydraulic cylinder when in the down position. As such, the lever may lower the ladder even during loss of hydraulic pressure.

The lever also has a neutral position and the lever is configured to return to the neutral position, such as by a spring return mechanism. As such, an operator may momentarily throw the lever to the up or down positions to raise or lower the retractable ladder but when the lever is released, the lever returns to the neutral position and the ladder stops moving.

The access control system further comprising a latching control circuit.

The latching control circuit comprises a ladder valve contact switch operably coupled to the ladder control lever and which opens or closes depending on the position of the ladder control lever and a ladder position sensor (such as a proximity switch) which detects if the retractable ladder is in the raised position.

The latching control circuit has a latching valve relay controlling a latching valve. The latching valve can pressurise the hydraulic cylinder.

The latching control system controls the hydraulic cylinder to keep the retractable ladder in the raised position when the ladder valve contact switch indicates that the ladder control lever is in the neutral position and the ladder position sensor detects that the retractable ladder is in the raised position.

As such, the present access control allows for momentary control of the retractable ladder and which latches the retractable ladder to the raised position by keeping the hydraulic cylinder pressurised thereby avoiding downward creep of the retractable ladder or use of mechanical latches to hold up the ladder.

To prevent or reduce false positive signals, a plurality of ladder proximity switches may be connected in series.

Further safety may be provided by use of additional interlocks which may include a seat pressure transducer interlock and/or a safety switch interlock.

The seat pressure transducer interlock may detect when an operator is seated within the control cabin. Furthermore, the safety switch interlock may interface a control switch in the control cabin of the excavator. The control switch may be the “server control switch” which is normally used by operators to control the operation of the excavator controls to be functional (such as slewing, digging, tramming and the like).

As such, the latch system would only hold the ladder in the raised position not only when the ladder position sensor detects that the retractable ladder is in the raised position but also when the operator is seated and the operational controls of the excavator are active.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a latching control circuit in accordance with an embodiment.

### DESCRIPTION OF EMBODIMENTS

An excavator comprises an access system comprising a retractable ladder and a hydraulic system comprising at least one hydraulic cylinder connected to the retractable ladder.

The hydraulic cylinder is operated to raise and lower the retractable ladder between raised and lowered positions.

An access control system for the access system comprises a ladder control lever connected to the hydraulic system.

The lever can be put in an up position which raises the ladder, a down position to lower the ladder and a neutral position.

The lever is configured to return to the neutral position, such as by a spring return. As such, an operator may momentarily push the lever to either of the up or down positions to control the ladder accordingly wherein, when released, the lever returns to the neutral position. The lever is preferably shrouded to prevent the lever from being deflected such as when being hit by a falling object or to prevent objects being hung from the lever and the like.

The lever may be connected to the hydraulic system such that when the lever is in the up position, the hydraulic cylinder is pressurised to raise the ladder and, when the lever is in the down position, pressure from the hydraulic cylinder is released to lower the ladder. As such, the lever can be put in the down position to lower the ladder under gravity when the engine is not running.

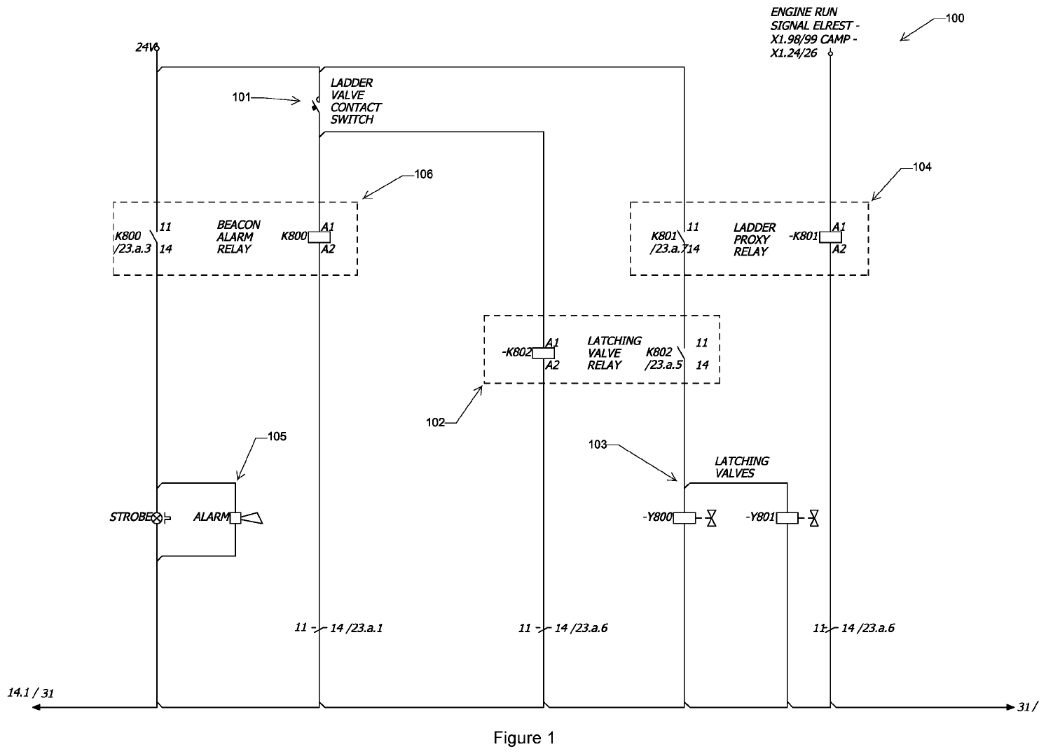

FIG. 1 shows a latching control circuit 100 which comprises a ladder valve contact switch 101 operably coupled to the ladder control lever.

A ladder position sensor detects if the retractable ladder is in the raised position. The ladder position sensor may comprise a ladder proximity switch. The ladder proximity switch may comprise a Reed switch which detects proximity of a ferromagnetic object. The ladder proximity switch may comprise a plurality of ladder proximity switches in series to reduce false positives.

The circuit 100 further comprises a latching valve relay 102 controlling at least one latching valve 103.

The latching valve 103 can pressurise the hydraulic cylinder. When the latching valve relay 102 is energised, the latching valve 103 may pressurise the hydraulic cylinder.

The circuit 100 keeps the retractable ladder in the raised position when the excavator engine is running (i.e., thereby supplying hydraulic pressure), the ladder valve contact switch 101 indicates that the ladder control lever is in the neutral position (i.e., an operator is not momentarily throwing the access control lever to either the up or down positions to raise or lower the retractable ladder) and the ladder proximity switch detects that the retractable ladder is in the raised position.

The latching control circuit 100 may further control the hydraulic cylinder to keep the retractable ladder in the raised position according to at least one interlock.

The at least one interlock may comprise an engine running signal interlock which is active when the engine is running.

The at least one interlock may comprise a seat pressure transducer interlock which is active when an operator is sitting on a seat in the control cabin of the excavator.

The at least one interlock may further comprise a safety switch interlock which is activated when a switch on the control panel of the control cabin is closed. The safety switch interlock may interface with the “servo control switch” which is closed for the operator controls to be functional (i.e., the server control switch is closed to enable slewing, digging, tramming and the like).

The circuit may comprise a ladder proximity relay 104 which is energised by the ladder proximity switch to close a circuit to the latching valves 103.

The ladder proximity switch may be connected in series with the at least one interlock. For example, the ladder proximity relay 104 would only close if the ladder proximity switch detects that the retractable ladder is in the raised position, the engine running interlock indicates that the engine is running, the seat pressure transducer interlock indicates that an operator is seated and the safety switch interlock indicates that the server control switch is closed.

The ladder proximity relay 104 may be arranged in series with the latching valve relay 102 as shown.

The access control system may further comprise a beacon alarm device 105, such as a strobe light and/or audible alarm device.

The beacon alarm device may operate according to the ladder valve contact switch 101. For example, the ladder valve contact switch 101 may close when the ladder control lever is out of the neutral position which complete the circuit to power the beacon alarm device.

The circuit 100 may comprise a beacon alarm relay 106 between the ladder valve contact switch 101 and the beacon alarm device 105 which is energised when the ladder valve contact switch 101 closes.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. An access control system for an excavator, the excavator comprising an access system comprising a retractable ladder and a hydraulic system comprising a hydraulic cylinder connected to the retractable ladder and which raises and lowers the retractable ladder between raised and lowered positions, the access control system comprising:
a ladder control lever connected to the hydraulic system, the lever having an up position which raises the ladder, a down position which lowers the ladder and a neutral position and wherein the ladder control lever returns itself to the neutral position;
a latching control circuit comprising:
a ladder valve contact switch operably coupled to the ladder control lever;
a ladder position sensor which detects if the retractable ladder is in the raised position;
a latching valve relay controlling a latching valve, the latching valve controlling the hydraulic cylinder, wherein the control system controls the hydraulic cylinder to keep the retractable ladder in the raised position when:
the ladder valve contact switch indicates that the ladder control lever is in the neutral position; and
the ladder position sensor detects that the retractable ladder is in the raised position.

2. A system as claimed in claim 1, wherein, in the up position, the ladder control lever pressurises the hydraulic cylinder.

3. A system as claimed in claim 2, wherein, in the down position, the ladder control lever releases pressure of the hydraulic cylinder.

4. A system as claimed in claim 1, wherein the lever is shrouded.

5. A system as claimed in claim 1, wherein the ladder position sensor comprises a ladder proximity switch.

6. A system as claimed in claim 1, wherein the ladder proximity switch comprises a Reed switch which detects proximity of a ferromagnetic object.

7. A system as claimed in claim 1, wherein the ladder proximity switch comprises a plurality of ladder proximity switches in series.

8. A system as claimed in claim 1, wherein the latching control circuit controls the hydraulic cylinder to keep the retractable ladder in the raised position according to at least one interlock.

9. A system as claimed in claim 8, wherein the at least one interlock comprises an engine running interlock.

10. A system as claimed in claim 8, wherein the at least one interlock comprises a seat pressure transducer interlock.

11. A system as claimed in claim 8, wherein the at least one interlock comprises a safety switch interlock.

12. A system as claimed in claim 8, wherein the latching control circuit comprises a ladder proximity relay energised by the ladder position sensor to close a circuit to the latching valve.

13. A system as claimed in claim 12, wherein the at least one interlock is in series with the ladder position sensor to energise the ladder proximity relay.

14. A system as claimed in claim 1, wherein the latching control circuit comprises a latching valve relay energised by the ladder valve contact switch to close a circuit to the latching valve.

15. A system as claimed in claim 1, further comprising a beacon alarm device which operates according to the ladder valve contact switch.

16. A system as claimed in claim 15, wherein the ladder valve contact switch closes when the ladder control lever is out of the neutral position to complete a circuit to power the beacon alarm device.

17. A system as claimed in claim 16, further comprising a beacon alarm relay between the ladder valve contact switch and the beacon alarm device which is energised when the ladder valve contact switch closes.
